(19) United States
(12) Patent Application Publication
(10) Pub. No.: US 2011/0080330 A1
(43) Pub. Date: Apr. 7, 2011

(54) MULTIBAND ANTENNA SYSTEM WITH SHIELD

(75) Inventors: Joong Hee LEE, Seongnam-si (KR); Yong JEE, Seoul (KR); Young Min SEO, Seoul (KR); Yo Han JEONG, Seoul (KR)

(73) Assignees: SAMSUNG ELECTRONICS CO. LTD., Suwon-si (KR); INDUSTRY-UNIVERSITY COOPERATION FOUNDATION SOKANG UNIVERSITY, Seoul (KR)

(21) Appl. No.: 12/899,824

(22) Filed: Oct. 7, 2010

(30) Foreign Application Priority Data
Oct. 7, 2009 (KR) 10-2009-0095350

(51) Int. Cl. H01Q 5/01; H01Q 13/00

(52) U.S. Cl. 343/785

(57) ABSTRACT

A multiband antenna system installed onto a circuit board of a mobile device is provided. The antenna system includes a planar dielectric substrate, an upper conductor formed on an upper surface of the dielectric substrate and shaped as a coplanar wave guide and includes first and second ground parts and a radiator, and a lower conductor formed on the lower surface of the dielectric substrate and shaped as a coplanar wave guide and includes third and fourth ground parts and an electrode part, via-holes that pass through the dielectric substrate and are electrically connected to the first ground part to the third, the second ground part to the fourth, and the radiator to the electrode part, respectively, and solder balls connect the electrode part to an electric wire of the circuit board and also the third and fourth ground parts to the ground of the circuit board.

### PRIORITY

This application claims the benefit under 35 U.S.C. §119(a) of a Korean patent application filed on Oct. 7, 2009 in the Korean Intellectual Property Office and assigned. Serial No. 10-2009-0095350, the entire disclosure of which is hereby incorporated by reference.

### JOINT RESEARCH AGREEMENT

The presently claimed invention was made by or on behalf of the below listed parties to a joint research agreement. The joint research agreement was in effect on or before the date the claimed invention was made and the claimed invention was made as a result of activities undertaken within the scope of the joint research agreement. The parties to the joint research agreement are Samsung Electronics Co., Ltd. and Industry-University Cooperation Foundation Sokang University.

### BACKGROUND OF THE INVENTION

1. Field of the Invention

The present invention relates to antenna systems for mobile devices. More particularly, the present invention relates to a multiband antenna system with a shield.

2. Description of the Related Art

With the development of mobile communication technology, mobile devices can provide a variety of mobile communication services to comply with a user's requests. Examples of the mobile communication services include a multimedia service, a wireless Internet service, and a satellite communication service as well as a voice communication service. The multimedia service can provide multimedia such as audio data or movies. The wireless Internet service can allow users to use the Internet at a high speed event during the movement. The satellite communication service can allow for mobile communication regardless of location.

If such various mobile communication services are provided to users via a single mobile device using a variety of frequency bands, the convenience and efficiency for the use of the services will increase. As a result, technology is required that can operate a single antenna system of the mobile devices in various frequency bands.

A conventional ¼λ, monopole antenna or helical antenna protrudes from the mobile device when it's installed, which can be inconvenient in use and easily broken. To resolve this problem, a built-in antenna has been researched and developed.

As the built-in antennas are reduced in size, their radiation efficiency is lowered and their frequency band is also narrower. In addition, the antenna gain also decreases. Despite the performance deterioration according to the size reduction of the antenna system, the mobile devices are requested to be small and to have high performance. In addition, the antenna system installed to such mobile devices is also required to be small and to have high performance. Built-in antennas are restricted in size to be installed into a relatively small space of the mobile devices.

Therefore, a need exists for an antenna system without space restriction in a mobile device.

### SUMMARY OF THE INVENTION

An aspect of the present invention is to address at least the above-mentioned problems and/or disadvantages and to provide at least the advantages described below. Accordingly, an aspect of the present invention is to provide an antenna system that operates in various frequency bands.

Another aspect of the present invention is to provide an antenna system that is formed on a printed circuit board without space-restriction, thereby increasing space utilization in the mobile device.

In accordance with an aspect of the present invention, an antenna system installed onto a circuit board of a mobile device is provided. The system includes a planar dielectric substrate, upper and lower conductors, via-holes, and solder balls. The upper conductor is formed on the upper surface of the dielectric substrate and shaped as a coplanar wave guide. The upper conductor includes first and second ground parts and a radiator. The lower conductor is formed on the lower surface of the dielectric substrate and shaped as a coplanar wave guide. The lower conductor includes third and fourth ground parts and an electrode part. The via-holes pass through the dielectric substrate. The via-holes electrically connect the first ground part to the third, the second ground part to the fourth, and the radiator to the electrode part, respectively. The solder balls connect the electrode part to an electric wire of the circuit board and also the third and fourth ground parts to the ground of the circuit board.

The radiator may be configured in such a way that first, second and third patterns, which have a monopole radiation pattern, are connected to each other. The radiator may generate a resonant frequency depending on the lengths of the first, second and third patterns.

The first pattern may be formed, in straight, parallel to the first and second ground parts, according to the configuration of the coplanar wave guide.

The second pattern may be formed, in straight, perpendicular to the first pattern, with respect to a certain point of the first pattern.

The third pattern may be shaped as a meander and is superimposed with the second pattern.

The antenna system may further include a medium conductor. The medium conductor may have the same pattern as the upper conductor, may be located between the upper and lower conductors, and may separate the planar dielectric substrate into two layers.

The dielectric substrate may form a groove on its lower surface on which the lower conductor is not formed. The groove may be formed on an area that is exposed. The groove may be formed to be depressed, by a certain depth, from the lower surface of the dielectric substrate.

Other aspects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other aspects, features, and advantages of certain exemplary embodiments of the present invention will be more apparent from the following description taken in conjunction with the accompanying drawings, in which:

FIG. 1A is a top perspective view of a dielectric substrate according to an exemplary embodiment of the present invention;

FIG. 1B is a bottom perspective view of a dielectric substrate according to an exemplary embodiment of the present invention;

FIG. 1C is a cross-sectional view taken along line A-A′ of a dielectric substrate according to an exemplary embodiment of the present invention;

FIG. 2A is a top perspective view illustrating hidden parts of a dielectric substrate according to an exemplary embodiment of the present invention;

FIG. 2B is a bottom perspective view illustrating hidden parts of a dielectric substrate according to an exemplary embodiment of the present invention;

FIGS. 3A to 3C illustrate top views of a dielectric substrate describing a radiator including a multiband according to an exemplary embodiment of the present invention;

FIG. 4 illustrates an antenna system installed onto a circuit board according to an exemplary embodiment of the present invention;

FIG. 5 is a view describing a configuration of an antenna system according to an exemplary embodiment of the present invention;

FIG. 6 illustrates a plot of a returns loss of an antenna system according to an exemplary embodiment of the present invention; and

FIGS. 7A-7C illustrate radiation patterns according to an exemplary embodiment of the present invention.

Throughout the drawings, it should be noted that like reference numbers are used to depict the same or similar elements, features, and structures.

### DETAILED DESCRIPTION OF EXEMPLARY EMBODIMENTS

The following description with reference to the accompanying drawings is provided to assist in a comprehensive understanding of exemplary embodiments of the invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. In addition, descriptions of well-known functions and constructions may be omitted for clarity and conciseness.

The terms and words used in the following description and claims are not limited to the bibliographical meanings, but, are merely used by the inventor to enable a clear and consistent understanding of the invention. Accordingly, it should be apparent to those skilled in the art that the following description of exemplary embodiments of the present invention is provided for illustration purpose only and not for the purpose of limiting the invention as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

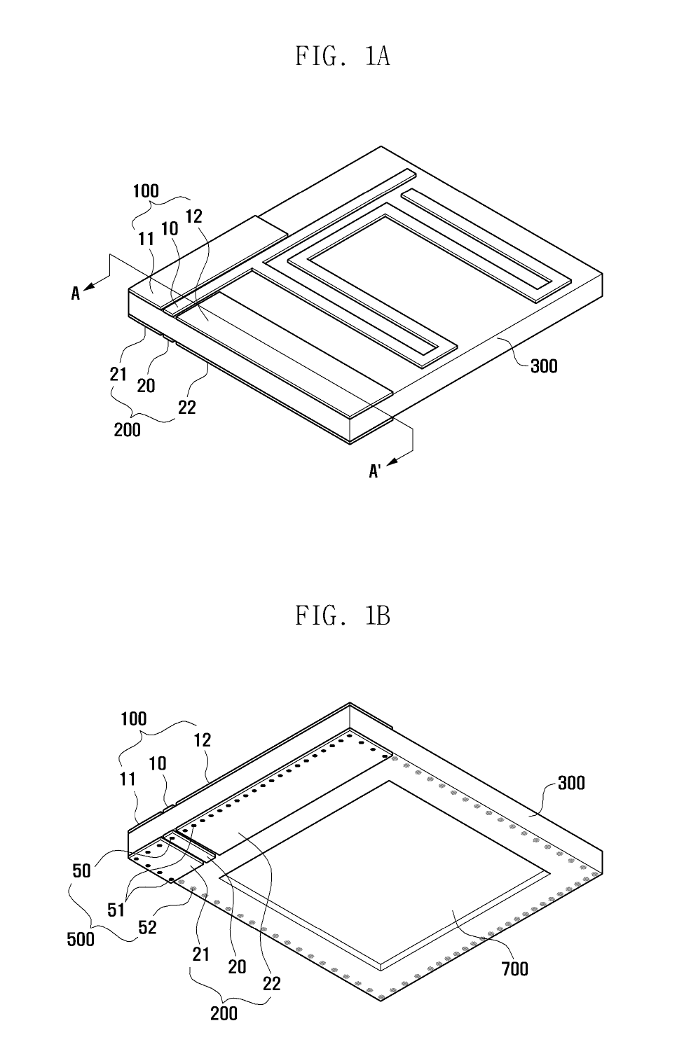

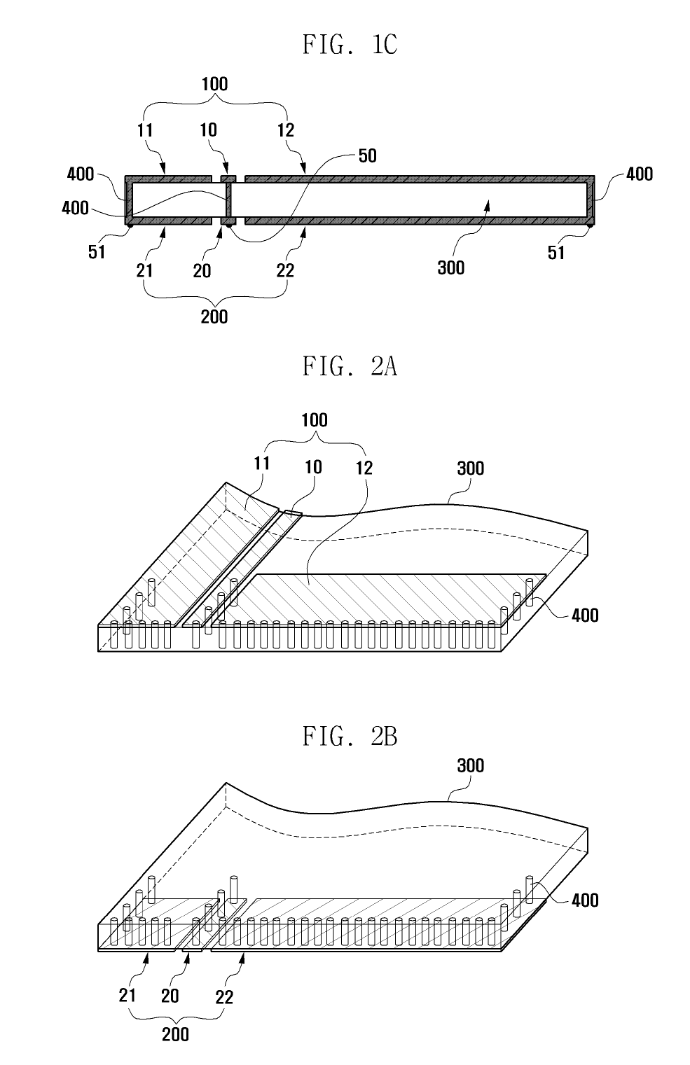

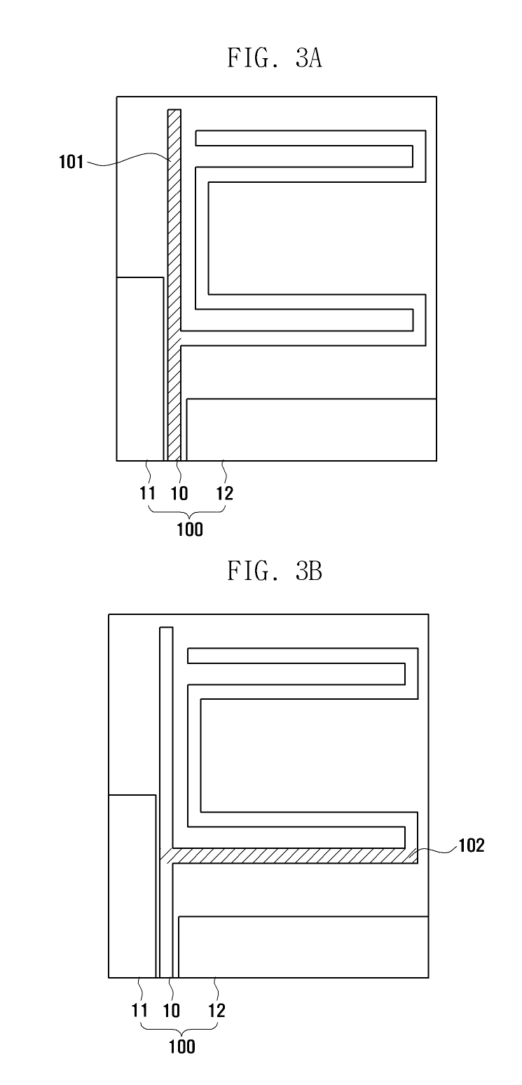

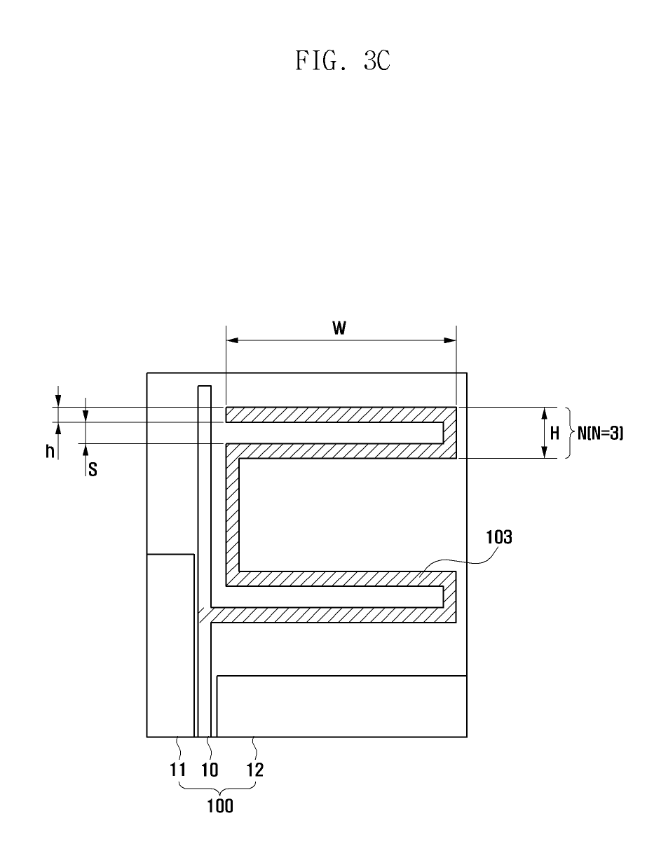

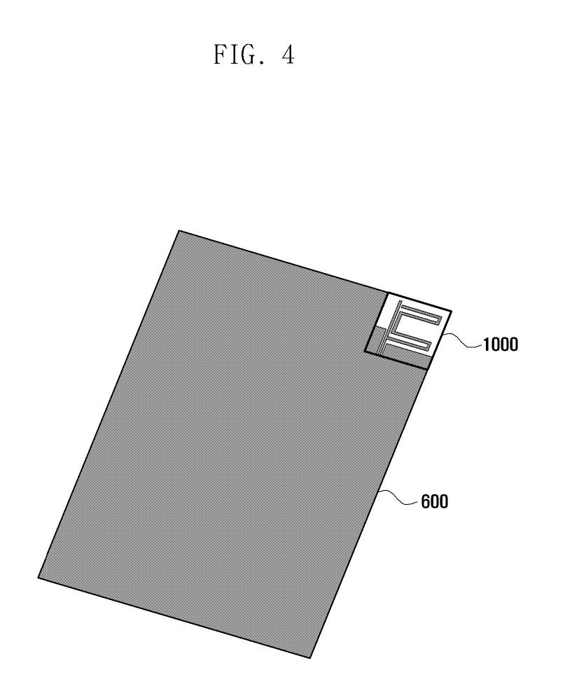

FIG. 1A is a top perspective view of a dielectric substrate according to an exemplary embodiment of the present invention. FIG. 1B is a bottom perspective view of a dielectric substrate. FIG. 1C is a cross-sectional view taken along line A-A′ of a dielectric substrate according to an exemplary embodiment of the present invention. FIG. 2A is a top perspective view illustrating hidden parts of a dielectric substrate according to an exemplary embodiment of the present invention. FIG. 2B is a bottom perspective view illustrating hidden parts of a dielectric substrate according to an exemplary embodiment of the present invention.

The antenna system includes a planar dielectric substrate 300, and upper and lower conductors 100 and 200. The upper and lower conductors 100 and 200 are formed on upper and lower surfaces of the planar dielectric substrate 300, correspondingly and respectively. The upper and lower conductors 100 and 200 are also shaped as a Coplanar Wave Guide (CPW).

The upper and lower conductors 100 and 200 are electrically connected to each other by via-holes 400 passing through the dielectric substrate 300.

The dielectric substrate 300 forms solder balls along the edge on the lower surface. The dielectric substrate 300 is installed to the circuit board via the solder balls. The circuit board refers to a board that has electric parts used for the mobile device.

The dielectric substrate 300 may be made of at least one of Low Temperature Co-fired Ceramic (LTCC), ceramic, Printed Circuit Board (PCB), silicon (Si), and Gallium Arsenide (GaAs). The dielectric substrate 300 dimensions may be 27×28×0.6 mm³ (LWH).

Referring to FIG. 1A, the upper conductor 100 is shaped as a Coplanar Wave Guide (CWP). The upper conductor 100 includes a first ground part 11 and a second ground part 12 and a radiator 10 which are located at the same plane. The first ground part 11 and the second ground part 12 are located at both sides on the dielectric substrate 300. The radiator 10 is located between the first ground part 11 and the second ground part 12.

The radiator 10 has a planar monopole antenna pattern. More particularly, the radiator 10 may be implemented with a combination of various patterns in order to achieve a resonant frequency in a multiband.

Referring to FIG. 1B, the lower conductor 200 is also shaped as a CWP, corresponding to the upper conductor 100. The lower conductor 200 includes a third ground part 21 and a fourth ground part 22 and an electrode part 20 which are located at the same plane. The third ground part 21 and the fourth ground part 22 are located at both sides on the dielectric substrate 300. The electrode part 20 is located between the third ground part 21 and the fourth ground part 22.

The dielectric substrate 300 may optionally form a groove 700 on its lower surface on which the lower conductor 200 is not formed. The area on which the groove 700 will be formed is exposed. The groove 700 is formed to be depressed, by a certain depth, from the lower surface of the dielectric substrate 300. The groove 700 may allow for installation of circuitry that is formed on the lower surface of the circuit board of the antenna system.

As described above, the upper conductor 100 and the lower conductor 200 are formed so that their locations may correspond to each other, with respect to the dielectric substrate 300. That is, the first ground part 11 and the second ground part 12 correspond to the third ground part 21 and the fourth ground part 22, respectively. In addition, the radiator 10 also corresponds to the electrode part 20.

Referring to FIGS. 2A and 2B, the via-holes 400 electrically connect the upper conductor 100 and the lower conductor 200. That is, the first ground part 11 and the third ground part 21 are electrically connected to each other through the via-holes 400. Likewise, the second ground part 12 and the fourth ground part 22 are electrically connected to each other. In addition, the radiator 10 is also electrically connected to the electrode part 20.

Referring to FIGS. 1B and 2A, the dielectric substrate 300 forms solder balls 50, 51, and 52 (hereinafter numbered by 500) along the edge on the lower surface. The solder balls 500 serve to install the antenna system to the circuit board.

The electrode solder ball 50 electrically connects the electrode part 20 to an electric wire (not illustrated) of the circuit board. The ground solder ball electrically connects the third ground part 21 and the fourth ground part 22 to the ground (GND). The support solder ball 52 supports the antenna system.

The antenna system receives a signal via the electric wire, transfers the signal via the electrode solder ball 50, the electrode part 20, and the via-holes 400, and then radiates the signal via the radiator 10. The antenna system is also grounded via the first and second ground parts 11 and 12, the via-holes 400 corrected to the first ground part 11 and the second ground part 12, the third ground part 21 and the fourth ground part 22, and the ground solder ball 51.

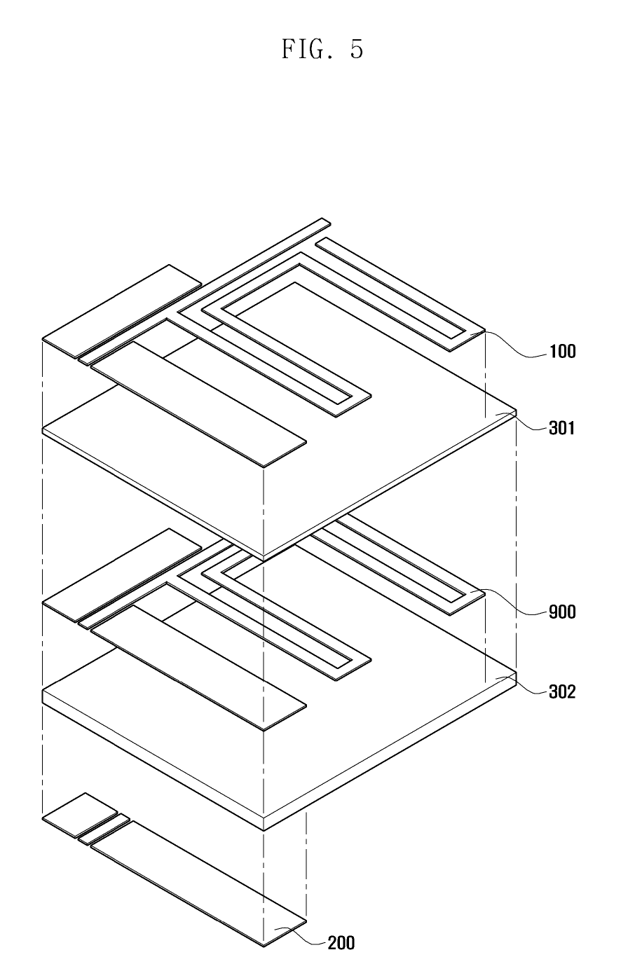

FIGS. 3A to 3C illustrate top views of the dielectric substrate describing a radiator including a multiband according to an exemplary embodiment of the present invention.

Referring to FIGS. 3A to 3C, the radiator 10 is implemented as a monopole shape. The radiator 10 includes first to third patterns 101, 102, and 103. For sake of convenience, the first to third patterns 101, 102, and 103 are displayed with slant lines to distinguish from other components. The radiator 10 generates resonant frequencies in the first to third bands corresponding to first to third patterns 101, 102, and 103, respectively.

Referring to FIG. 3A, the first pattern 101 is located between the first ground part 11 and the second ground part 12 forming a CPW, and spaced apart from the first ground part 11 and the second ground part 12 by a certain interval, respectively. The first pattern 10 is arranged straight and parallel to the first ground part 11 and the second ground part 12. Since the first pattern 101 forms a monopole antenna pattern, the first pattern 101 length is ¼λ of the first band. The first band may be 1.8 GHz, for example.

Referring to FIG. 3B, the second pattern 102 is formed straight and perpendicular to the first pattern 101. Like the first pattern 101, the second pattern 102 forms a planar monopole radiation pattern. The second pattern 102 has a length of ¼λ, of the second band. The second band may be 2.1 GHz, for example.

Referring to FIG. 3C, the third pattern 103 is formed to be superimposed with the second pattern 102 and shaped as a meander. An antenna system shaped as a meander may be made in such a way that a wire is sinuously bent. The parameter of the antenna system may be determined by a length (H) and width (W) of the antenna, a number of bends (N), height of wire (h), and the spacing of the wire (S).

The resonant frequency of the antenna is determined according to the length of the third pattern 103. Therefore, the third pattern 103 is required to be bent so that its length is ¼λ, corresponding to the resonant frequency. In this case, the area, occupied by the antenna pattern determining a resonant frequency in a higher band, may be reduced. Therefore, the third pattern 103 is formed to have a length of ¼λ of the third band, according to the type of meander. For example, the third pattern 103 has an about ¼λ of 850 MHz and forms an operation band at 0.8 GHz.

As described above, the antenna system may simultaneously receive signals in a multiband, for example, 800 MHz, 1800 MHz, and 2100 MHz bands. That is, the antenna system according to an exemplary embodiment of the present invention may be implemented in such a way to generate resonant frequencies in the multiband. For example, the antenna system may be manufactured in such a way to be used for Global System for Mobile Communication (GSM), Digital Communication System (DCS), Personal Communication System (PCS) and Wideband. Code Division Multiple Access (WCDMA), and the like.

The antenna system may generate frequency bands, such as 0.8 GHz, 1.8 GHz, and 2.1 GHz. Since the frequency band of an antenna operation, 1.8 GHz, corresponds to a frequency band for DCS, 1.71.88 GHz band, and simultaneously to a frequency band for PCS, 1.85˜1.99 GHz band, the antenna may be designed to include a 2.1 GHz band of operation and a 0.8 GHz band. Therefore, the antenna system may be manufactured corresponding to four bands as described above.

In the following description, a shielding function of the antenna system of the invention is explained in detail below.

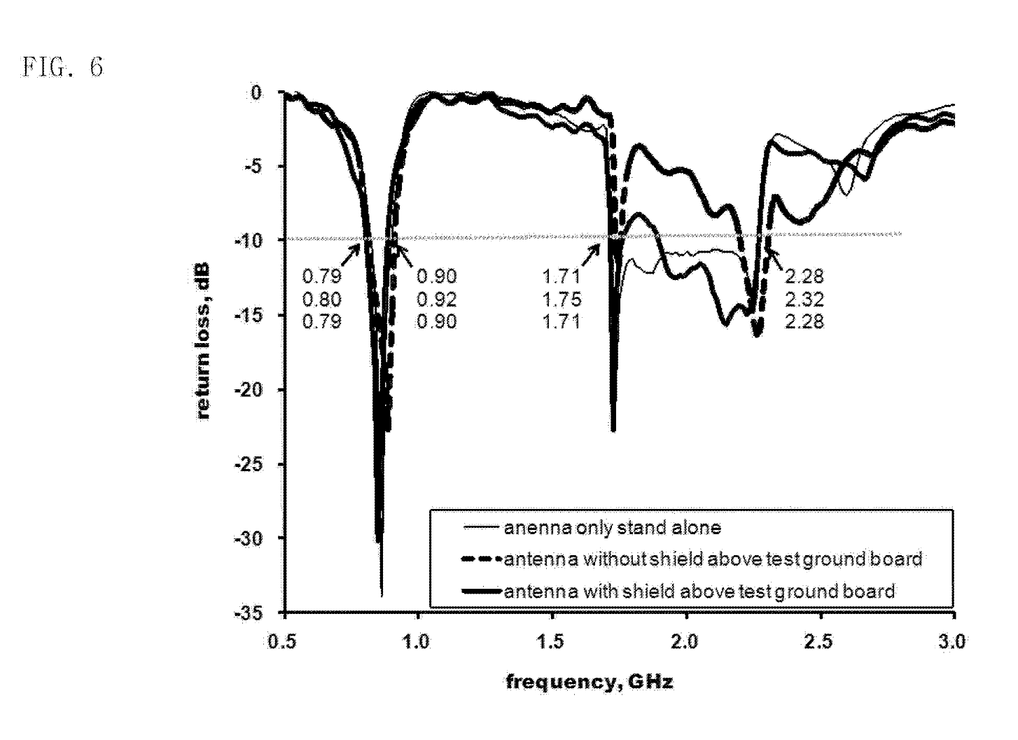

FIG. 4 illustrates an antenna system installed onto a circuit board according to an exemplary embodiment of the present invention.

Referring to FIG. 4, the antenna system 1000 is installed to the circuit board 600 via the solder balls 500. The circuitry of the circuit board 600 under the lower surface of the antenna system 1000 is electrically shielded.

The via-holes 400 and the lower conductor 200 are electrically grounded to the ground (GND) via the ground solder balls 51. That is, the via-holes 400 serve as a ground. Therefore, the antenna system 1000 has a ground configuration as the ground (GND), the ground solder balls 51, the lower conductor 200 and the via-holes 400 are connected to each other. The ground configuration allows the dielectric substrate 300 and the circuitry of the circuit board 600 under the antenna system 1000 to be shielded from operation frequency signals of the antenna.

If the circuitry of the circuit board 600 is operated in a band that differs from an operation frequency of the antenna, the circuitry signals may be interfered with ultrahigh frequency or electromagnetic waves. That is, RF signals in various bands, generated as the upper conductor 100 performs an antenna operation on the dielectric substrate 300, may cause an ultrahigh frequency signal interference phenomenon. In this case, the circuitry of the circuit board under the antenna system 1000 may malfunction due to the signal interference. To prevent the malfunction, a shielding function is performed using the ground configuration described above. That is, shielding is achieved in such a way that the ultra-high frequency signals of the antenna system 1000 is separated from the operation frequency signals of the circuitry of the circuit board 600 under the antenna system 1000.

Although conventional antenna systems separates the circuitry of the circuit board from other components using a shield member, the antenna system 1000 in an exemplary embodiment of the present invention shields the antenna patterns from the circuitry of the circuit board 600 via the configuration of the antenna. Therefore, the interval between the antenna system 1000 and the circuit board 600 may be largely reduced.

A configuration of the antenna system according to an exemplary embodiment of the present invention is described in detail below.

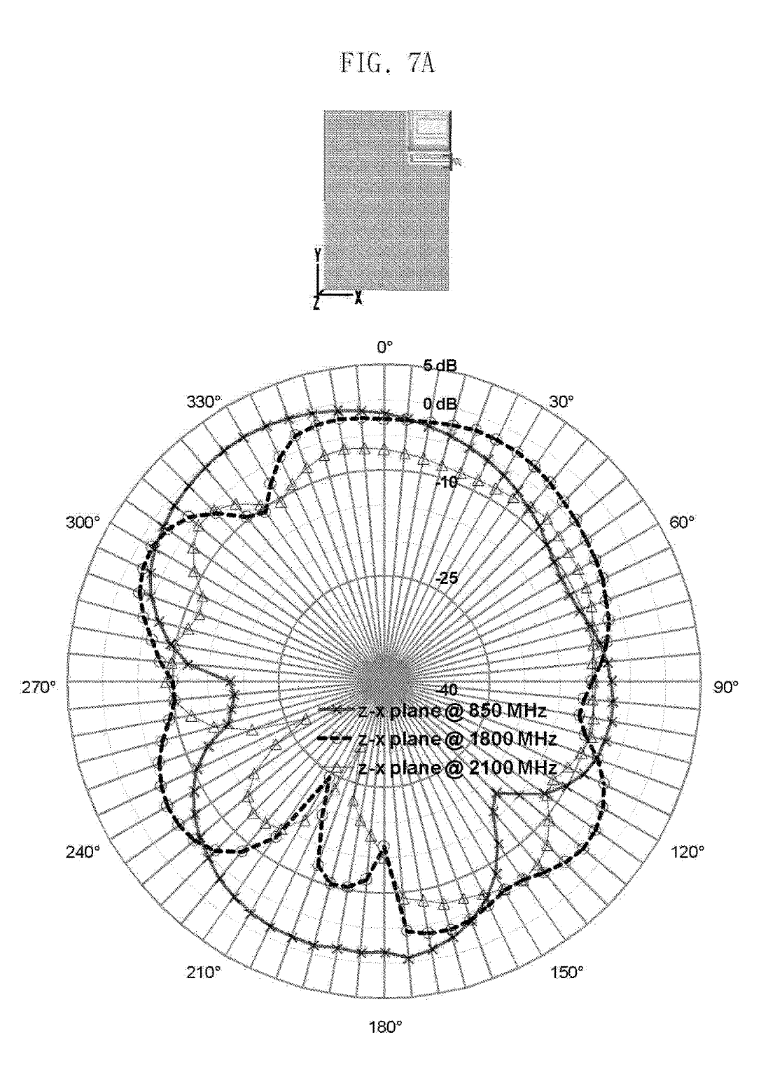

FIG. 5 is a view describing a configuration of an antenna system according to an exemplary embodiment of the present invention.

Referring to FIG. 5, the antenna system is configured, from the bottom, in such a way to arrange, in order, a lower conductor 200, a second dielectric substrate 302, a medium conductor 900, a first dielectric substrate 301 and an upper conductor 100. The upper conductor 100 and the medium conductor 900 have the same pattern.

The antenna system of FIG. 5 is modified from the antenna system described in FIGS. 1A to 1C in such a way that the medium conductor 900 having the same pattern as the upper conductor 100 is further located between the dielectric substrates 300, i.e., the first dielectric substrate 301 and the second dielectric substrate 302.

The upper conductor 100, the first dielectric substrate 301, the medium conductor 900, the second dielectric substrate 302, and the lower conductor 200 may be equal to or greater than 0.05 mm, 0.15 mm, 0.05 mm, 0.35 mm, and 0.05 mm, in thickness, respectively.

More particularly, the medium conductor 900 has the same pattern as the upper conductor 100 of FIG. 1A. The medium conductor 900 also has the via-holes and solder balls that are of the same configuration as the upper conductor 100.

If the upper conductor 100 has a thickness equal to or greater than 0.5 mm, the upper conductor 100 may generate a corresponding radiation pattern and thus serve as a proper antenna. The medium conductor 900 serves to assist the upper conductor 100 to stably exert the antenna feature.

Since the antenna system of FIG. 5 has two conductor layers that are relatively thin, for example, 0.05 mm, and forms spacing according to the thickness of the first dielectric substrate 301, the antenna system has an effect as if it is configured to have an electrode equal to or greater than 0.15 mm thick.

The second dielectric substrate 302 that is 0.35 mm thick serves to properly achieve resonant frequencies for an antenna function and simultaneously insulates the circuitry of the circuit board from the second dielectric substrate 302.

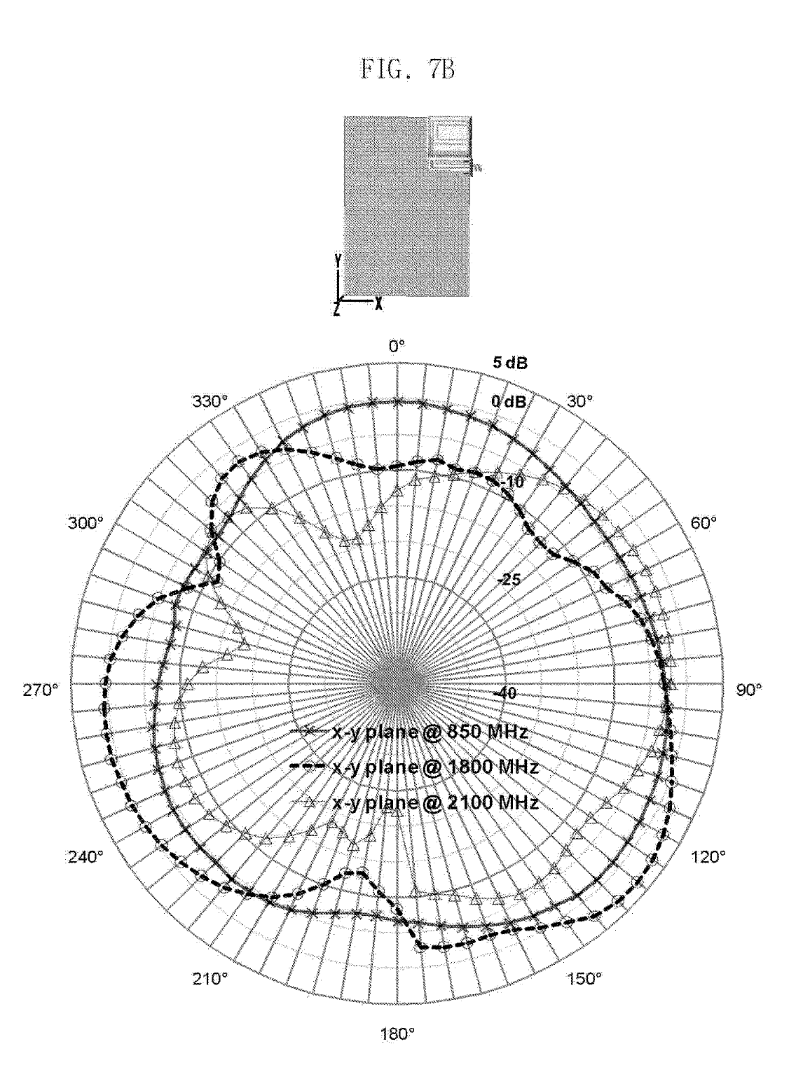

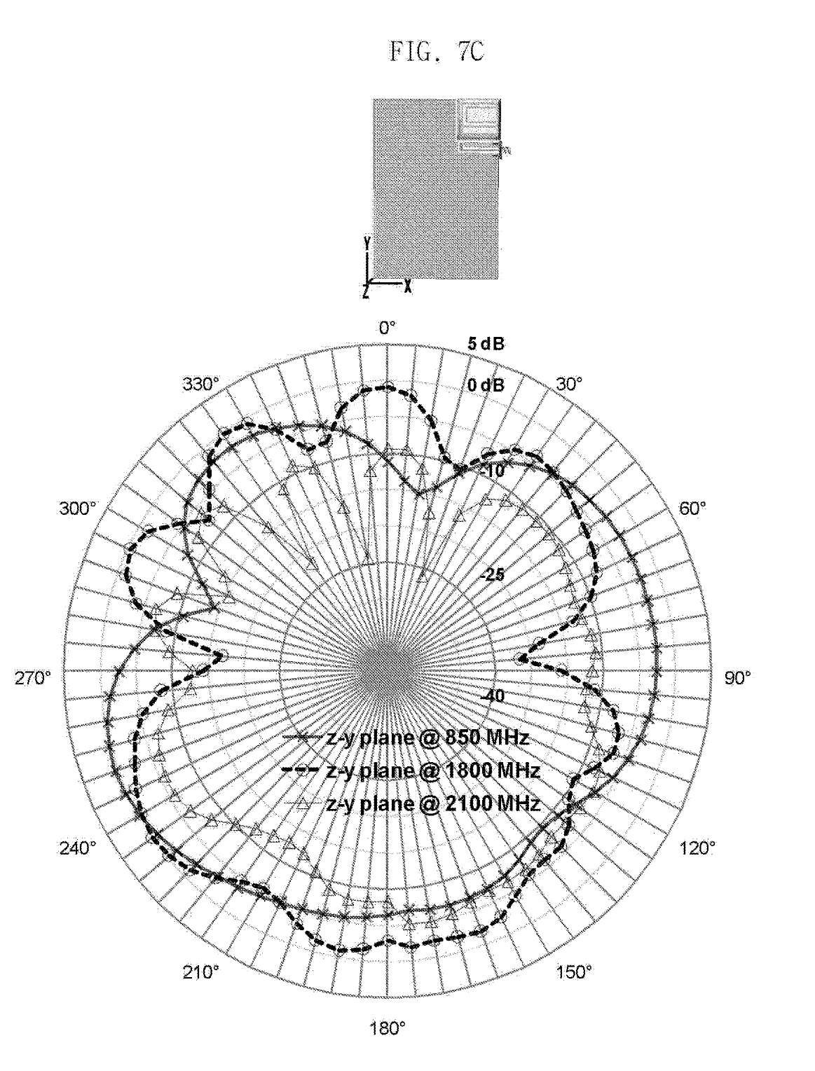

In the foregoing description, the configuration of the antenna system has been described. The performance of the antenna system will be described below with reference to FIGS. 6 and 7A-7C.

FIG. 6 illustrates a plot of a returns loss of an antenna system according to an exemplary embodiment of the present invention.

Referring to FIG. 6, if the output of the antenna system has a return loss of −10 dB, the first to third bands are established. For the same output, the operation band of the antenna system keeps the feature of a previously designed band (i.e., antenna only stand alone) although there is a little interference due to the circuit board 600 of the mobile device.

FIGS. 7A-7C illustrate radiation patterns according to an exemplary embodiment of the present invention.

Referring to FIGS. 7A-7C, three bands are all showing an omni-directional radiation pattern. That is, although the antenna system 1000 is installed to the circuit board 600, the antenna system 1000 may keep the omni-directional radiation feature for GSM, DCS, PCS and WCDMA bands.

The measurements of radiation pattern at the center frequency with respect to the respective bands show all the omni-directional radiation in z-x, x-y, and z-y planes. The antenna system 1000 of the invention may minimize the influence of the circuit board 600 through the electromagnetic shield configuration and may simultaneously operate in multiband.

As described above, the antenna system in the exemplary embodiments of the present invention includes a radiator. The antenna system, serving as a single antenna, can provide wireless communication services in multiband. The circuitry in the board of the mobile device is shielded from the area in the board to which the antenna system is installed, thereby resolving the space-restriction in the mobile device.

While the present invention has been shown and described with reference to certain exemplary embodiments thereof, it will be understood by those skilled in the art that various changes in form and details may be made therein without departing from the spirit and scope of the invention as defined in the appended claims and their equivalents.

What is claimed is:

1. An antenna system installed onto a circuit board of a mobile device, the system comprising:
a planar dielectric substrate;
an upper conductor formed on an upper surface of the dielectric substrate and shaped as a coplanar wave guide, wherein the upper conductor includes a first ground part and a second ground part and a radiator formed between the first ground part and the second ground part;
a lower conductor formed on a lower surface of the dielectric substrate and shaped as a coplanar wave guide, wherein the lower conductor includes a third ground part and a fourth ground part and a electrode part formed between the third ground part and the fourth ground part;
via-holes passing through the planar dielectric substrate, where the via-holes electrically connecting the first ground part to the third ground part, the second ground part to the fourth ground part, and the radiator to the electrode part; and
solder balls for connecting the electrode part to an electric wire of the circuit board and the third ground part and the fourth ground part to ground of the circuit board.

2. The antenna system of claim 1, wherein the dielectric substrate comprises at least one of Low Temperature Co-fired Ceramic (LTCC), ceramic, Printed Circuit Board (PCB), silicon (Si), and Gallium Arsenide (GaAs).

3. The antenna system of claim 1, wherein:
the radiator is configured such that a first pattern, a second pattern and a third pattern, which comprise a monopole radiation pattern, are connected to each other, and generates a resonant frequency based on first pattern, second pattern and third pattern lengths.

4. The antenna system of claim 3, wherein the first pattern is formed straight and parallel to the first ground part and the second ground part, according to a coplanar wave guide configuration.

5. The antenna system of claim 4, wherein the second pattern is formed straight and perpendicular to the first pattern, with respect to a certain point of the first pattern.

6. The antenna system of claim 5, wherein the second pattern forms a planar monopole radiation pattern.

7. The antenna system of claim 5, wherein the third pattern is shaped as a meander and is superimposed with the second pattern.

8. The antenna system of claim 1, further comprising:
a medium conductor comprising the same pattern as the upper conductor is located between the upper conductor and the lower conductor, and separates the planar dielectric substrate into two layers.

9. The antenna system of claim 1, wherein:
the dielectric substrate forms a groove on its lower surface on which the lower conductor is not formed;
the groove is formed on an area that is exposed; and
the groove is formed to be depressed, by a certain depth, from the lower surface of the dielectric substrate.

10. The antenna system of claim 9, wherein the groove may allow installation of circuitry that is formed on the lower surface of the circuit board.

11. The antenna system of claim 1, wherein at least one of the solder balls supports the antenna system.
